(19) United States
(12) Patent Application Publication
(10) Pub. No.: US 2025/0183792 A1
(43) Pub. Date: Jun. 5, 2025

(54) POWER CONVERSION DEVICE AND ITS OPERATING METHOD

(71) Applicant: KOREA ELECTRONICS TECHNOLOGY INSTITUTE, Seongnam-si (KR)

(72) Inventors: Jun Hyuk CHOI, Bucheon-si (KR); Jin Hong KIM, Suwon-si (KR); Joon Sung PARK, Seoul (KR); Byong Jo HYON, Anyang-si (KR); Yongsu NOH, Seoul (KR); Sang Min PARK, Bucheon-si (KR); Dongmyoung JOO, Bucheon-si (KR); Daeyeon HWANG, Incheon (KR); Poo Reum JANG, Incheon (KR); Hyoung-Kyu YANG, Seoul (KR)

(21) Appl. No.: 18/965,218

(22) Filed: Dec. 2, 2024

(30) Foreign Application Priority Data
Dec. 1, 2023 (KR) 10-2023-0172108
Nov. 29, 2024 (KR) 10-2024-0175410

(51) Int. Cl. H02M 1/36; H02M 3/00; H02M 3/335

(52) U.S. Cl. CPC H02M 1/36; H02M 3/01; H02M 3/33573

(57) ABSTRACT

A power conversion device is proposed. The device may include a receiver receiving a signal. The device may also include a soft start controller performing a soft start operation, determining two or more soft start ending conditions, and ending the soft start operation if the soft start ending conditions are all satisfied. The device may also include a signal controller controlling a signal after the soft start operation is ended, determining an ending condition of the power conversion device, and ending the power conversion device if the ending condition of the power conversion device is satisfied.

### STATEMENT REGARDING GOVERNMENT

### Sponsored Research or Development

The present disclosure is supported by Korean national research and development project as follows:

### CROSS-REFERENCE TO RELATED APPLICATIONS

This application claims priority under 35 U.S.C. § 119 to Korean Patent Application No. 10-2023-0172108, filed on Dec. 1, 2023, and Korean Patent Application No. 10-2024-0175410, filed on Nov. 29, 2024, in the Korean Intellectual Property Office, the disclosure of each of which is incorporated herein by reference in its entirety.
[Unique assignment number] 20225500000120
[Ministry Name] Ministry of Trade, Industry and Energy
[Project management (professional) organization name] Korea Institute of Energy Technology Evaluation and Planning
[Research field name] Renewable Energy Core Technology Development Project
[Research project name] Development of measurement, diagnosis, and reliability evaluation technology for ultra-high voltage direct current distribution
[Name of project carrying out organization] Electric Power Research Institute
[Research period] Sep. 1, 2022 to Aug. 31, 2027

### BACKGROUND

### Technical Field

The following disclosure relates to a power conversion device and its operating method.

### Description of Related Technology

A frequency-controlled resonant converter (e.g., LLC converter, series resonant converter, or parallel resonant converter) may perform a soft start to reduce voltage and/or current stresses on a power semiconductor device, a resonant component (e.g., inductor or capacitor), or a transformer during its initial oscillation.

### SUMMARY

One aspect is a power conversion device for continuously and efficiently controlling the voltage and current of a frequency-controlled resonant converter during its start-up, and its operating method.

Aspects of the present disclosure are not limited to the disclosed aspects. That is, other aspects that are not mentioned here may be obviously understood by those skilled in the art from the following description.

Another aspect is a power conversion device including: a receiver receiving a signal; a soft start controller performing a soft start operation, determining two or more soft start ending conditions, and ending the soft start operation if the soft start ending conditions are all satisfied; and a signal controller controlling a signal after the soft start operation is ended, determining an ending condition of the power conversion device, and ending the power conversion device if the ending condition of the power conversion device is satisfied.

The device may further include a controller controlling the power conversion device, wherein the signal is a command voltage or a command current that controls an operation of the controller.

The soft start ending conditions may be two or more of the following conditions: a duty ratio is 50 percent or more, an output current of the controller is the command current or more, and an output voltage of the controller is the command voltage or more’

The soft start controller may update an integral controller value based on a duty ratio at a soft start ending time point before the soft start is ended.

The device may further include a converter including a power semiconductor, a transformer, or a resonant component.

Another aspect is an operating method of a power conversion device, the method including: receiving, by a receiver, a signal; performing, by a soft start controller, a soft start operation, determining two or more soft start ending conditions, and ending the soft start operation if the soft start ending conditions are all satisfied; and controlling, by a signal controller, a signal after the soft start operation is ended, determining an ending condition of the power conversion device, and ending the power conversion device if the ending condition of the power conversion device is satisfied.

The signal may be a command voltage or a command current that controls an operation of a controller controlling the power conversion device.

The soft start ending conditions may be two or more of the following conditions: a duty ratio is 50 percent or more, an output current of the controller is the command current or more, and an output voltage of the controller is the command voltage or more.

The method may further include updating, by the soft start controller, an integral controller value based on a duty ratio at a soft start ending time point before the soft start is ended.

The method may further include converting power by a converter including a power semiconductor, a transformer, or a resonant component.

Other features and aspects will be apparent from the following detailed description, the drawings, and the claims.

### BRIEF DESCRIPTION OF THE DRAWINGS

FIG. 1 is an exemplary block diagram showing a power conversion device according to some embodiments.

FIG. 2 is an exemplary circuit diagram showing a converter of the power conversion device according to some embodiments.

FIG. 3 is an exemplary graph for describing a soft start operation algorithm.

FIG. 4 is an exemplary graph for describing the soft start operation algorithm through an operation of the power conversion device according to some embodiments.

FIG. 5 is an exemplary flowchart showing an operating method of a power conversion device according to some embodiments.

### DETAILED DESCRIPTION

After a soft start is completed, a controller of a power conversion device may need to follow a voltage or current command by being operated based on the commands. However, during this process, a transient state may occur where the voltage or current command is not sequentially satisfied.

Therefore, there is an emerging need for an initial start-up method for continuously controlling the output of the converter based on the voltage and current commands.

Hereinafter, embodiments of the present disclosure are described in detail with exemplary drawings. When adding a reference number to a component in each drawing, it should be noted that the same reference numbers are used to designate the same or equivalent components even if the components are shown in different drawings. In addition, in describing the embodiments disclosed in this document, a detailed description of a related known configuration or function is omitted if this description is determined to interfere with the understanding of the embodiments of the present disclosure.

In addition, terms “first”, “second”, A, B, (a), (b), and the like, may be used in describing components of an embodiment of the present disclosure. These terms are used only to distinguish any component from other components, and features, sequences, or the like of the corresponding components are not limited to these terms. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as such in the present application.

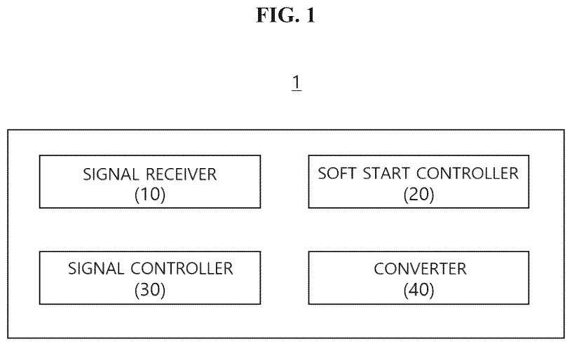

FIG. 1 is an exemplary block diagram showing a power conversion device according to some embodiments.

Referring to FIG. 1, a power conversion device 1 according to some embodiments may include a signal receiver 10, a soft start controller 20, a signal controller 30, and a converter 40.

Hereinafter, the signal receiver 10, soft start controller 20, and signal controller 30 of the power conversion device 1 may be soft blocks included in a controller of the power conversion device 1, and each block may be merged with each other.

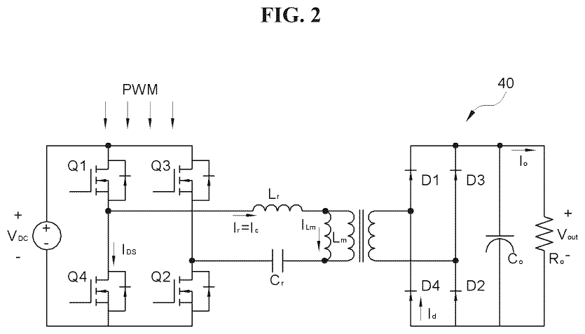

FIG. 2 is an exemplary circuit diagram showing a converter of the power conversion device according to some embodiments.

Referring to FIG. 2, the converter 40 of the power conversion device 1 according to some embodiments may be a frequency-controlled resonant converter.

Hereinafter, the converter 40 of the power conversion device 1 according to some embodiments is described as the frequency-controlled resonant converter.

The converter 40 may perform a soft start to reduce voltage and current stresses on a power semiconductor, a resonant component, or a transformer during its operation.

The description examines the operation of the converter 40 based on its soft start operation.

The power conversion device and its operating method according to the embodiments may control the output of the converter to match the voltage and current commands in a process of operating the controller of the power conversion device.

The power conversion device and its operating method according to the embodiments may continuously control the output voltage and current of the frequency-controlled resonant converter during its start-up.

The power conversion device and its operating method according to the embodiments may continuously perform voltage and/or current control without any transient state after an initial start-up of the frequency-controlled resonant converter through a software method without adding any additional hardware.

The power conversion device and its operating method according to the embodiments may reduce voltage and current stresses on the power semiconductor, the resonant component, or the transformer.

The power conversion device and its operating method according to the embodiments may prevent an overshoot of output current/voltage commands and prevent its malfunction caused by overcurrent/overvoltage. The output current is controlled by the controller.

In addition, the power conversion device and its operating method according to the embodiments may rapidly follow a target value of the output current/voltage commands.

In addition, the power conversion device and its operating method according to the embodiments may allow the power conversion device to start up even in a field where a light load operation is required, such as in a charging start-up sequence of an electric vehicle charger.

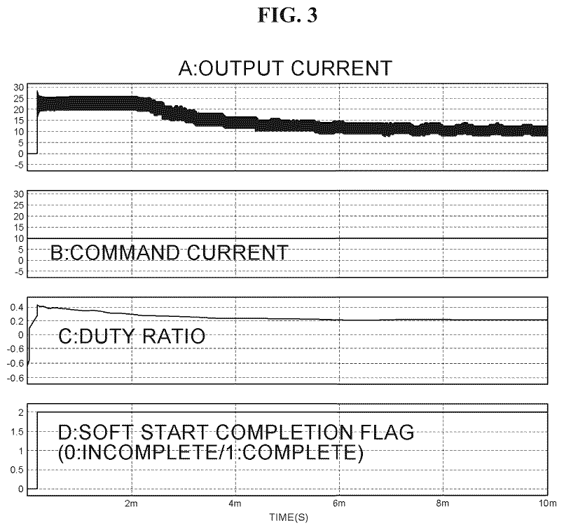

FIG. 3 is an exemplary graph for describing a soft start operation algorithm.

Referring to FIGS. 2 and 3, a method may be performed to gradually increase a pulse width (duty ratio) of a pulse width modulation (PWM) that is input into power semiconductor switches Q1 to Q4 from 0 percent to 50 percent.

The soft start may be ended if the pulse width of the PWM reaches 50 percent, and the signal controller may be operated to operate the power semiconductor to follow a command voltage or a command current received through the signal receiver. However, during this process, a transient state may occur where the command voltage or command current is not satisfied momentarily.

The description describes an operation of the power conversion device 1 according to some embodiments to prevent the occurrence of the transient state with reference to FIGS. 2, 4 and 5.

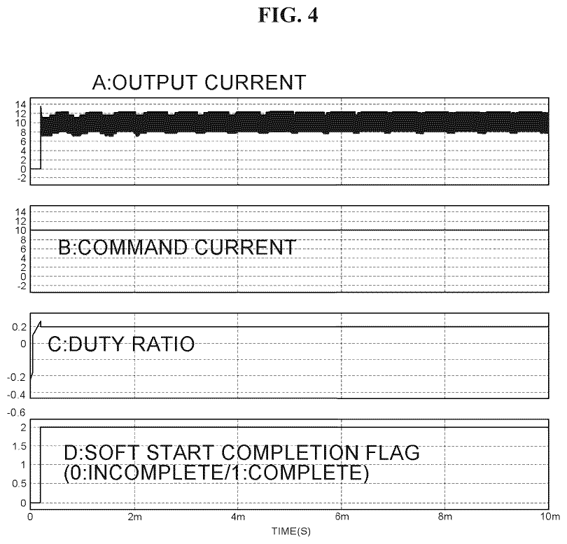

FIG. 4 is an exemplary graph for describing the soft start operation algorithm through the operation of the power conversion device according to some embodiments.

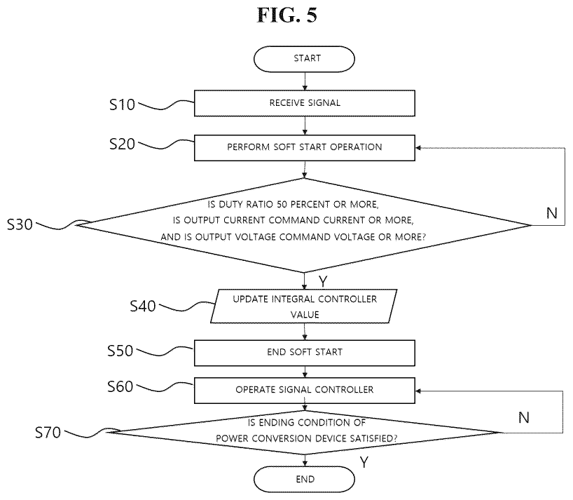

FIG. 5 is an exemplary flowchart showing an operating method of a power conversion device according to some embodiments.

Referring to FIGS. 1, 2, 4, and 5, the operation of the power conversion device 1 may be initiated according to some embodiments.

A signal may be received by the signal receiver 10 (S10). Here, the signal received by the signal receiver 10 may be a command signal or the command voltage. The command signal or the command voltage may be a signal to operate the controller of the power conversion device 1.

The soft start controller 20 may then be operated (S20). In more detail, during an initial operation of the power conversion device 1, the soft start may be performed by the soft start controller 20 to reduce the voltage and/or current stresses on the power semiconductor devices Q1 to Q4, resonant components L and C, the transformer, or the like, included in the converter 40.

Here, the soft start controller 20 may determine whether the following conditions are all satisfied: the duty ratio is 50 percent or more, the output current is the command current or more, and the output voltage is greater than the command voltage (S30).

The soft start controller 20 may continuously perform the soft start operation if any of the following conditions is not satisfied: the duty ratio is 50 percent or more, the output current is the command current or more, and the output voltage is greater than the command voltage (S30-N).

The soft start controller 20 may recognize a time point at which the conditions are all satisfied as a time point at which the soft start is ended, and update an integral controller value to continuously control the voltage and the current based on the duty ratio at this time point (S40) if it is determined that the following conditions are all satisfied: the duty ratio is 50 percent or more, the output current is the command current or more, and the output voltage is greater than the command voltage (S30-Y).

The soft start controller 20 may then end the soft start (S50).

The signal controller 30 may then be operated (S60). It may then be determined whether an ending condition of the power conversion device is satisfied (S70).

The operation of the power conversion device 1 may be ended if the ending condition is satisfied (S70-Y), and the operation of the signal controller 30 may be continuously operated if the ending condition is not satisfied (S70-N).

The signal controller 30 may be a voltage and current controller of the power conversion device 1.

The power conversion device 1 according to some embodiments may be applied to the frequency-controlled resonant converter for performing the soft start and may also be used for the start-up in a light load condition such as the electric vehicle charger.

As shown in FIG. 5, the power conversion device 1 according to some embodiments may be operated to improve the reliability of the soft start; may reduce the voltage and current stresses on the power semiconductor, the resonant component, or the transformer disposed in the converter 40; may prevent the overshoot of the output current/voltage commands and prevent its malfunction caused by the overcurrent/overvoltage; may rapidly follow a target value of the output current/voltage commands; and may also be applied to the field where the light load operation is required, such as in the charging start-up sequence of the electric vehicle charger.

As set forth above, the power conversion device and its operating method according to the embodiments may control the output of the converter to match the voltage and current commands in the process of operating the controller of the power conversion device.

In addition, the power conversion device and its operating method according to the embodiments may continuously control the output voltage and current of the frequency-controlled resonant converter during its start-up.

In addition, the power conversion device and its operating method according to the embodiments may continuously perform the voltage and/or current control without any transient state after the initial start-up of the frequency-controlled resonant converter through the software method without adding any additional hardware.

In addition, the power conversion device and its operating method according to the embodiments may reduce the voltage and current stresses on the power semiconductor, the resonant component, or the transformer.

In addition, the power conversion device and its operating method according to the embodiments may prevent the overshoot of the output current/voltage commands and prevent its malfunction caused by the overcurrent/overvoltage.

In addition, the power conversion device and its operating method according to the embodiments may rapidly follow the target value of the output current/voltage commands.

In addition, the power conversion device and its operating method according to the embodiments may allow the power conversion device to start up even in the field where the light load operation is required, such as in the charging start-up sequence of the electric vehicle charger.

The spirit of the present disclosure is illustratively described hereinabove. It will be appreciated by those skilled in the art that various modifications and alterations may be made without departing from the essential characteristics of the present disclosure.

Accordingly, the embodiments of the present disclosure are not intended to limit the spirit of the present disclosure, but rather to describe the same, and the spirit and scope of the present disclosure are not limited to the embodiments described above. Therefore, the scope of the present disclosure should be interpreted by the following claims, and it is to be interpreted that all the spirits equivalent to the following claims fall within the scope of the present disclosure.

What is claimed is:

1. A power conversion device comprising:
a receiver configured to receive a signal;
a soft start controller configured to perform a soft start operation, determine two or more soft start ending conditions, and end the soft start operation in response to the soft start ending conditions being all satisfied; and
a signal controller configured to control a signal after the soft start operation is ended, determine an ending condition of the power conversion device, and end the power conversion device in response to the ending condition of the power conversion device being satisfied.

2. The device of claim 1, further comprising a controller configured to control the power conversion device,
wherein the signal comprises a command voltage or a command current configured to control an operation of the controller.

3. The device of claim 2, wherein the soft start ending conditions comprise two or more of the following conditions: a duty ratio is 50 percent or more, an output current of the controller is the command current or more, or an output voltage of the controller is the command voltage or more.

4. The device of claim 1, wherein the soft start controller is configured to update an integral controller value based on a duty ratio at a soft start ending time point before the soft start is ended.

5. The device of claim 1, further comprising a converter including at least one of a power semiconductor, a transformer, or a resonant component.

6. An operating method of a power conversion device, the method comprising:
receiving, by a receiver, a signal;
performing, by a soft start controller, a soft start operation, determining two or more soft start ending conditions, and ending the soft start operation in response to the soft start ending conditions being all satisfied; and
controlling, by a signal controller, a signal after the soft start operation is ended, determining an ending condition of the power conversion device, and ending the power conversion device in response to the ending condition of the power conversion device being satisfied.

7. The method of claim 6, wherein the signal comprises a command voltage or a command current configured to control an operation of a controller controlling the power conversion device.

8. The method of claim 7, wherein the soft start ending conditions comprise two or more of the following conditions: a duty ratio is 50 percent or more, an output current of the controller is the command current or more, or an output voltage of the controller is the command voltage or more.

9. The method of claim 6, further comprising updating, by the soft start controller, an integral controller value based on a duty ratio at a soft start ending time point before the soft start is ended.

10. The method of claim 6, further comprising converting power by a converter including a power semiconductor, a transformer, or a resonant component.
